(19) United States
(12) Patent Application Publication
(10) Pub. No.: US 2021/0120117 A1
(43) Pub. Date: Apr. 22, 2021

(54) Non-cellular wireless Bluetooth device

(71) Applicant: Paul Ackel, Wayne, NJ (US)

(72) Inventor: Paul Ackel, Wayne, NJ (US)

(21) Appl. No.: 16/994,791

(22) Filed: Aug. 17, 2020

Related U.S. Application Data
(60) Provisional application No. 62/915,717, filed on Oct. 16, 2019.

(51) Int. Cl. H04M 1/725; H04M 1/03; H04R 1/10

(52) U.S. Cl. CPC H04M 1/7253; H04R 1/1041; H04M 1/03

(57) ABSTRACT

The present invention relates to features incorporated into a Non-Cellular Bluetooth device for use transmitting microphone signals to a Smartphone, tablet, or other Bluetooth device. A Non-Cellular Bluetooth device consisting of an a jack which allows connections of an external microphone or headset with a microphone to the input jack of a device such as a 4-pin 3.5 mm jack, USB-C jack or Lightning jack and other similar devices having an input jack suitable for connecting an external microphone. The Non-Cellular Bluetooth device may or may not also include an adjustable sensitivity control to compensate for different microphone sensitivities.

### BACKGROUND OF THE INVENTION

### Field of the Invention

The present invention generally relates to wireless communication, and more specifically relates to features of a Bluetooth device typically used with wireless telephone systems commonly known as Smartphones and tablets and concerns a method for wirelessly transmitting audio signals based on a Bluetooth standard used as a wireless microphone unit.

### Background

The present invention relates to a Non-Cellular Bluetooth device (Transmitter, Receiver, or combination Transmitter and Receiver) that that pairs with a Smartphone (such as an iPhone or Android phone) or other Bluetooth devices to provide a method to transmit microphone sounds to a Smartphone, tablet, or other Bluetooth devices. It also provides for adjustable microphone sensitivity and support for internal and external microphones.

Typically, a Non-Cellular Bluetooth device (Transmitter, Receiver, or combination Transmitter and Receiver) would incorporate an internal microphone to transmit sound via a Bluetooth connection to a Smartphone, tablet, or other Bluetooth device. Many Smartphones and tablets incorporate a 3.5 mm headphone jack that has 4 pins to use external microphones instead of the internal microphone. The 4 pins are used for left and right channel output, ground, and a microphone input. Non-Cellular Bluetooth devices typically will have an internal microphone and a 3-pin headphone jack. 3-Pin headphone jacks and charging ports do not normally support the connection of external microphones in Non-Cellular Bluetooth devices. The 3 pins are used for left and right channel output and ground. One option to allow the connection of an external microphone would be to have a jack in the Non-Cellular Bluetooth device with 4 pins like the type used with Smartphones.

Another option to connect a microphone would be to connect to the multi-pin jack on a device such as an iPhone or Android Smartphone or tablet that is typically used for charging. In most cases the charging port on a Smartphone or tablet is either a USB or Lightning jack integrated into the device. As such, another option to connect an external microphone to a Non-Cellular Bluetooth device is to connect it to the charging port and enable the external microphone to provide a microphone input and/or to provide the output signal from the Bluetooth device to the microphone.

What would be needed to allow for an internal or external microphone on a Non-Cellular Bluetooth device would be a method to switch between either an internal microphone or and external microphone. This capability to switch can be either done with a switch or with a circuit that defeats the internal microphone whenever it senses an external microphone has been connected and initiates the internal microphone whenever the external microphone has been removed.

The sensitivity of the internal microphone on a Non-Cellular Bluetooth device is typically set to optimize the sensitivity of the dedicated internal microphone. In many cases the microphone sensitivity is not ideal for the application being used. Because of the various sensitivities and requirements to use an external microphone a sensitivity adjustment may be needed to accommodate a range of different microphones and situations.

What is needed then, is a Non-Cellular Bluetooth device that provides a method for connection of an external microphone, that provides a method to switch between an internal and external microphone, and that may provide a method to adjust for different microphone sensitivities.

### BRIEF SUMMARY OF THE INVENTION

In order to solve the above problems, the present invention provides a solution for using an external microphone and to provide adjustment for different microphone sensitivities using a non-cellular Bluetooth device.

### BRIEF DESCRIPTION OF THE SEVERAL VIEWS OF THE DRAWINGS

FIG. 1 is an example of a circuit board of the invention;

FIG. 2 is a multi-sided view of an example of the invention;

FIG. 3 is a view showing a microphone selector switch (I-Internal, E-External) and the microphone sensitivity switch (H-High, M-Medium, L-Low) in an example of the invention;

### DETAILED DESCRIPTION OF THE INVENTION

In order to solve the above problems, the present invention provides a solution for using an external microphone and to provide adjustment for different microphone sensitivities.

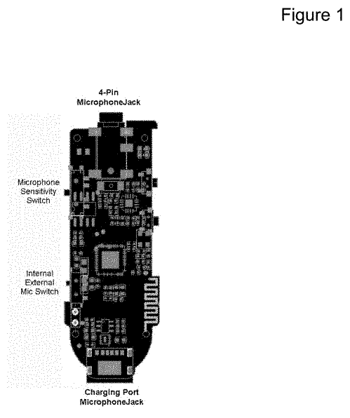

FIG. 1 is a circuit board example embodiment of the present invention. A wireless Non-Cellular Bluetooth device is provided with a 4-pin 3.5 mm jack like those used in Smartphones. The 4 pins are used for left and right channel output, ground, and a microphone input.

The circuit board example also shows a jack used as a charging port, like those used in Smartphones, that would accept an external microphone input, such as a USB or Lightning jack. The charging port would accept input from an external microphone to be used in place of or in addition to the internal microphone.

The circuit board example also shows the capability to adjust the microphone sensitivity using a switch (as shown) or with a continuous control or buttons with a circuit or capability using software to adjust the microphone sensitivity higher or lower to compensate for different microphone sensitivities or situations where higher or lower sensitivity is required.

The circuit board example also shows the capability to switch between an internal microphone or an external microphone. This capability to switch can be either done with a switch (as shown) or with a circuit that defeats the internal microphone whenever it senses an external microphone has been connected and initiates the internal microphone whenever the external microphone has been removed.

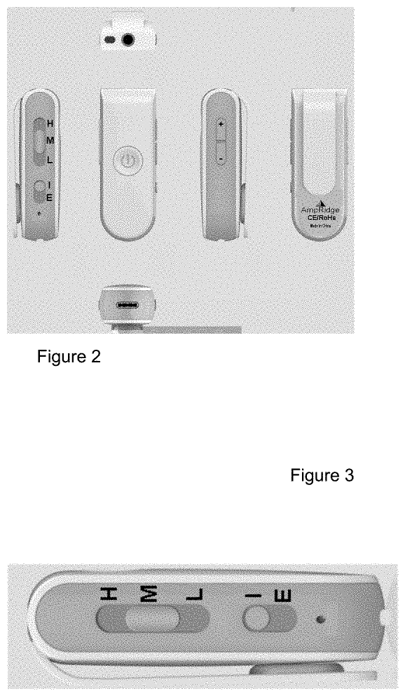

FIG. 2 is an example of the outer shell of the present invention. A wireless Non-Cellular Bluetooth device is provided with a 4-pin 3.5 mm jack like those used in Smartphones. The 4 pins are used for left and right channel output, ground, and a microphone input.

The example also shows a jack used as a charging port, like those used in Smartphones, that would accept an external microphone input, such as a USB or Lightning jack. The charging port would accept input from an external microphone to be used in place of or in addition to the internal microphone.

The circuit board example also shows the capability to adjust the microphone sensitivity using a switch (as shown) or with a continuous control or buttons with a circuit or capability using software to adjust the microphone sensitivity higher or lower to compensate for different microphone sensitivities or situations where higher or lower sensitivity is required.

The circuit board example also shows the capability to switch between an internal microphone or an external microphone. This capability to switch can be either done with a switch (as shown) or with a circuit that defeats the internal microphone whenever it senses an external microphone has been connected and initiates the internal microphone whenever the external microphone has been removed.

FIG. 3 is an example of the outer shell of the present invention. The example shows a switch which is provided with a circuit or capability using software to adjust the microphone sensitivity higher or lower to compensate for different microphone sensitivities or situations where higher or lower sensitivity is required.

The example also shows the capability to switch between an internal microphone or an external microphone. This capability to switch can be either done with a switch (as shown) or with a circuit that defeats the internal microphone whenever it senses an external microphone has been connected and initiates the internal microphone whenever the external microphone has been removed.

The invention claimed is:

1. A Non-Cellular Bluetooth device consisting of a jack that will support the connection of an external microphone. This could be a 4-pin jack using a tip-ring-ring-sleeve design that typically used to connect a microphone to the headphone jack on Smartphones and/or a charging port that supports the connection of an external microphone like a USB or Lightning connector.

2. A Non-Cellular Bluetooth device consisting of the option for an adjustable sensitivity control or switch(es) to adjust for different microphone sensitivities.

3. A Non-Cellular Bluetooth device that can switch between an internal microphone and an external microphone.
